(19) United States
(12) Patent Application Publication
(10) Pub. No.: US 2008/0043619 A1
(43) Pub. Date: Feb. 21, 2008

(54) METHOD AND APPARATUS FOR CONTROLLING ARQ AND HARQ TRANSMISSIONS AND RETRANSMISSIONS IN A WIRELESS COMMUNICATION SYSTEM

(75) Inventors: Mohammed Sammour, Montreal (CA); Arty Chandra, Manhasset Hills, NY (US); Stephen E. Terry, Northport, NY (US); Jin Wang, Central Islip, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/842,555

(22) Filed: Aug. 21, 2007

Related U.S. Application Data
(60) Provisional application No. 60/839,107, filed on Aug. 21, 2006.

(51) Int. Cl. H04L 12/26; H04L 1/18; H04L 12/56

(52) U.S. Cl. 370/231; 370/236; 370/349; 370/394; 370/468; 714/748

(57) ABSTRACT

A transmitter may instruct a receiver to move a receive window if the transmitter cannot retransmit a packet in response to an automatic repeat request (ARQ) status report and a hybrid ARQ (HARQ) feedback error report. The transmitter may advance a transmit window upon receipt of a local acknowledgement if the packet is in an ongoing flow and advance the transmit window when the packet is acknowledged by a status report if the packet is an isolated packet. The transmitter may perform a retransmission based on context in which the retransmission is requested. The transmitter may send an acknowledgement to the status report or the HARQ feedback error report. The transmitter may specify whether an HARQ feedback error report or a status report is allowed. The receiver may adjust the level of robustness and error protection for the HARQ feedback based on an indication from the transmitter.

### CROSS REFERENCE TO RELATED APPLICATION

This application claims the benefit of U.S. provisional application No. 60/839,107 filed Aug. 21, 2006, which is incorporated by reference as if fully set forth.

### FIELD OF INVENTION

The present invention is related to wireless communication systems, such as third generation partnership project (3GPP) universal mobile telecommunication system (UMTS), long term evolution (LTE), or high speed packet access (HSPA) enhancements (HSPA+). More particularly, a method and apparatus for controlling automatic repeat request (ARQ) and hybrid ARQ (HARQ) transmissions and retransmissions in a wireless communication system is disclosed.

### BACKGROUND

3GPP has recently initiated the LTE program to bring new technology, new network architecture and configuration, and new applications and services to the wireless cellular network in order to provide improved spectral efficiency, reduced latency, faster user experiences, and richer applications and services with less cost.

In Release 6, the radio link control (RLC) entities perform error correction and recovery via ARQ, flow control, in-sequence delivery (re-ordering), duplicate detection, segmentation, re-segmentation, concatenation, service data unit (SDU) discard, and the like. There are three types of RLC entities: transparent mode (TM), unacknowledged mode (UM), and acknowledged mode (AM) RLC entities. The TM and UM modes do not provide error correction or recovery, while the AM mode supports error correction and recovery via ARQ.

In Release 6, the RLC entities segment an RLC SDU into fixed-size RLC protocol data units (PDUs). Conventionally, RLC PDUs have a semi-static (configured) fixed size, and RLC PDUs are identified by adding RLC PDU sequence numbers (SNs). For LTE, various SDU segmentation schemes have been proposed where the RLC PDU size will not be fixed, but may change depending on the radio conditions. On the other hand, the identification of an RLC PDU, (or an RLC segment in general), may be performed via an SDU number and segment offset within the SDU, as opposed to conventional PDU sequence numbering. The segment offset may either be a number defining the order of the segment within the SDU. Alternatively, the offset may be defined as a starting offset, (e.g., in bytes), to identify the beginning of the segment within the SDU, and either of the size of the segment, (e.g., in bytes), or an ending offset, (e.g., in bytes), to identify the end of the segment.

FIG. 1 shows a conventional RLC control PDU (C-PDU) format. The RLC C-PDU 100 includes a data/control (D/C) field 102, a PDU type filed 104, super-fields 106 (SUFIs) and a padding (PAD) 108. The D/C field 102 is set to ‘0’ to indicate that the RLC PDU is a C-PDU. The PDU type field 104 indicates the type of the RLC PDU, (e.g., a status PDU, a reset PDU, and a reset positive acknowledgement (ACK) PDU). A status PDU conveys ACK or negative acknowledgement (NACK) information. An ACK is used for moving a transmit window used for flow control between the ARQ transmitter and the ARQ receiver. A NACK is used for error correction and recovery, (i.e., ARQ).

In UMTS, the ARQ transmitter relies on the status report to perform retransmissions of unsuccessfully transmitted PDUs. The ARQ receiver generates the status report when the ARQ receiver detects a missing PDU, when the ARQ receiver receives a packet from the ARQ transmitter that has a status polling bit set, when a cell change event occurs, or periodically. Having the ARQ receiver generate a status report based on missing SN detection is useful to quickly identify missing or erroneous packets. The ARQ transmitter may set a polling bit in a transmitted PDU to poll a status report from the ARQ receiver. For an isolated packet, where there is no further packet to be transmitted, the polling for subsequent generation of the status report from the ARQ receiver is useful for quickly identifying whether the isolated packet has been correctly received or not.

In Release 6, the ARQ transmitter and the ARQ receiver perform flow control using a windowing mechanism. The ARQ transmitter uses a transmit window in transmission of PDUs to the ARQ receiver, and the ARQ receiver uses a receive window in receiving the PDUs from the ARQ transmitter. In Release 6, the maximum window size is expressed as a number of PDUs. FIG. 2 shows a transmit window and a receive window.

At the ARQ transmitter, the lower edge of the transmit window, VT(A), is defined as the SN following the last in-sequence acknowledged PDU. The upper edge of the transmit window, VT(MS), is defined by VT(A)+Window_Size. The ARQ transmitter cannot transmit any PDU whose SN lies outside the transmit window. VT(S) represents the SN of the next PDU to be transmitted for the first time by the ARQ transmitter. VT(S)-VT(A) represents the transmit window size that is currently being utilized. VT(MS)-VT(A) represents the maximum transmit window size.

Moving the transmit window means moving the lower edge of the transmit window, (i.e., updating VT(A)), which also consequently implies moving the upper edge of the transmit window, VT(MS), since VT(MS)=(VT(A)+Window_Size). VT(A) is updated upon receiving a status report indicating an ACK for the PDU whose SN equals to VT(A). If the PDU whose SN is the same as that stored in VT(A) was not correctly received by the ARQ receiver, but the ARQ transmitter decides to give up on retransmitting that PDU, then VT(A) will be moved, (i.e., incremented). The ARQ transmitter sends a move receive window (MRW) command to the ARQ receiver to inform its decision to give up on retransmitting the PDU. Upon receiving an MRW_ACK message from the ARQ receiver that acknowledges the receipt of the MRW command, the ARQ transmitter increments the transmit window. The ARQ transmitter may set the polling bit for the status report when its utilized transmit window (VT(S)-VT(A)) reaches a certain percentage of the maximum window size.

At the ARQ receiver, the lower edge of the receive window, VR(R), is defined as the SN following the last in-sequence correctly received PDU. The upper edge of the receive window, VR(MS), is defined as VR(R)+Window_Size. The ARQ receiver cannot receive, (i.e., rejects or drops), any PDU whose SN lies outside the receive window. VR(H) represents the SN following the highest SN of any PDU successfully received by the ARQ receiver. VR(H)-VR(R) represents the receive window size that is currently being utilized. VR(MR)-VR(R) represents the maximum receive window size.

Moving the receive window means moving the lower edge of the receive window, (i.e., updating VR(R)), which also consequently implies moving the upper edge of the receive window, VR(MR) since VR(MR)=VR(R)+Window_Size). VR(R) is updated upon receipt of the PDU with an SN equal to VR(R), or upon receipt an MRW command from the ARQ transmitter.

Hybrid ARQ (HARQ) has been adopted for high speed downlink packet access (HSDPA) and high speed uplink packet access (HSUPA). While the ARQ provides error correction by retransmission of unsuccessfully delivered packets at the RLC layer, the HARQ ensures successful delivery at layer 1 and a medium access control (MAC) layer. HARQ is based on ACK/NACK feedback that positively or negatively acknowledges whether an HARQ PDU has been correctly received or not.

HARQ-assisted ARQ has been proposed. The idea of the HARQ-assisted ARQ is that the HARQ transmitter provides a local ACK or NACK to the ARQ transmitter based on the information obtained from the HARQ ACK or NACK, (i.e., from the HARQ feedback). The local NACK is generated when the HARQ transmitter gives up the HARQ transmission, (e.g., due to reaching the maximum retransmission limit), or when a NACK-to-ACK error is reported from the HARQ receiver to the HARQ transmitter. The local ACK is generated when none of the above two events for an ARQ packet has occurred during a predefined time interval.

There is a possibility that the HARQ feedback from the HARQ receiver is not correctly received by the HARQ transmitter. Hereinafter, this error will be called HARQ feedback error. The possible HARQ feedback errors are NACK-to-ACK error, discontinuous transmission (DTX)-to-ACK error, ACK-to-NACK error, and DTX-to-NACK error. The NACK-to-ACK error occurs when the HARQ receiver sent a NACK but the HARQ transmitter receives an ACK instead. The DTX-to-ACK error occurs when the HARQ receiver has not sent any feedback but the HARQ transmitter receives an ACK instead. The ACK-to-NACK error occurs when the HARQ receiver sent an ACK but the HARQ transmitter receives a NACK instead. The DTX-to-NACK error occurs when the HARQ receiver has not sent any feedback but the HARQ transmitter receives a NACK instead.

The ACK-to-NACK error and the DTX-to-NACK error will cause HARQ PDU to be retransmitted by the HARQ transmitter. So, there would be no loss of data but rather unnecessary redundancy. The NACK-to-ACK error and the DTX-to-ACK error are serious, since they can lead to data loss, (if not detected), and potential flow control window problems.

Detection of the HARQ feedback error typically focuses on detecting NACK-to-ACK or DTX-to-ACK errors since these can have damaging consequences on performance. The HARQ feedback error may be detected either at RLC/ARQ sub-layer or at MAC/HARQ sub-layer. Depending on the type of error and the characterization of the packet flow in which the error occurred, certain mechanisms are better suited than others to detect the error.

There are generally two types of packet flows to be considered. The first is an ongoing flow. An ongoing flow of packets refers to the case that a packet on which an HARQ feedback error has occurred is not the last packet of the flow, and that there will be a subsequent packet transmission within a reasonable amount of time. The other is an isolated packet case. An isolated packet refers to the case that there is only one packet in the flow or the packet is the last packet in the flow, or that a subsequent packet is transmitted after an unreasonable amount of time that is long enough to prevent detecting and reporting of the error within a necessary maximum time limit.

At the RLC sub-layer, the packet flow is an RLC/ARQ flow where packets belong to the same logical channel and share the same ARQ SN space. At the MAC/HARQ sub-layer, the packet flow is a MAC flow where packets from several logical channels are multiplexed into the same HARQ PDU. The HARQ PDU flow is a flow that goes from one source to the same destination, and is usually referring to an HARQ PDU flow mapped to a single HARQ process. However, the HARQ PDU flow may also refer to an HARQ PDU flow that is mapped to different HARQ processes dynamically or semi-statically. An HARQ PDU flow usually has HARQ-level SN updated on transmissions of new PDUs or on retransmissions of the same PDU. The HARQ-level sequence numbering is currently called a new data indicator (NDI) in HSDPA and a retransmission sequence number (RSN) in HSUPA. In HSDPA, the NDI is 1-bit that increments, (i.e., toggles), every new HARQ PDU, but does not change for retransmissions of the same HARQ PDU. In HSUPA, the RSN is 2-bits that increment at each retransmission of the HARQ PDU, but starts from ‘0’ when transmitting a new HARQ PDU.

The NACK-to-ACK error may be detected at the HARQ sub-layer when the HARQ receiver sent a NACK and was expecting the HARQ transmitter to retransmit the same HARQ PDU, but the HARQ Rx instead receives a different HARQ PDU, or does not receive any packet. The first case is useful for the ongoing flow case, while the second case is useful for the isolated packet case, particularly when synchronous HARQ is employed since the HARQ receiver knows when to expect the retransmission.

As an enhancement for detection of the HARQ feedback error, a cause value method has been proposed. The HARQ transmitter assists the HARQ receiver in detecting errors by including a ‘cause value’ field along with the transmitted packet to indicate the cause of the previous HARQ termination. For example, a cause value of ‘0’ indicates that the previous HARQ termination is because of ACK reception, and a cause value of ‘1’ indicates that the previous HARQ termination is not because of ACK reception, (e.g., because of reaching the maximum retransmission limit). With the cause value field, when the HARQ receiver receives a different HARQ PDU while expecting the same HARQ PDU, the HARQ receiver, before declaring that an error has occurred, examines the cause value field of this different HARQ PDU, and if the cause value field indicates that the previous HARQ termination is because of ACK reception, then the HARQ receiver can be sure that an HARQ feedback error has occurred. The cause value method is suited for the ongoing flow case, since it relies on a future packet to indicate the termination cause of a previous packet.

Once the HARQ feedback error has been detected by the HARQ receiver, the HARQ receiver sends an HARQ feedback error report to the HARQ transmitter. There have been several proposals regarding the content of the HARQ feedback error report. In one proposal, an HARQ feedback error report is piggybacked in a MAC PDU and contains the HARQ processor ID and the reception time of the packet that suffers the error. In another proposal, the HARQ error indication is sent in the form of a MAC C-PDU and not piggybacked in a MAC PDU reasoning that using the C-PDU ensures adequate reliability in sending the control message and also simplicity in processing it. Another contribution proposes reporting the physical layer frame number as part of the error report in order for the HARQ transmitter to determine on which HARQ packets the error has occurred.

The conventional methods for HARQ error detection and reporting at the HARQ-level have problems and shortcomings. The error report itself may not be reliable and may get lost. In addition, HARQ feedback error detection and reporting may be unnecessary when an HARQ PDU is aborted due to reaching the maximum number of retransmissions at the HARQ transmitter, when an HARQ PDU is aborted due to pre-emption by the HARQ transmitter in order to schedule other (higher priority) data, or when an HARQ PDU contains UM traffic. In the first and second cases, the situation occurred because of a deliberate decision by the HARQ transmitter and there is no error or unknown information that the HARQ receiver needs to convey to the HARQ transmitter. The cause value method may resolve the problem since by setting the cause value field to ‘1’, the HARQ receiver will know that the previous HARQ termination is not because of ACK reception, which means that there was no NACK-to-ACK error. The third case cannot be resolved using the cause value method, since the cause value field describes the termination cause of the previous packet, not the content or RLC/ARQ mode of the data itself. For example, if the data contained within the HARQ PDU does not require RLC/ARQ level retransmission, (e.g., the data uses RLC/ARQ UM or TM), which is the case for many real-time services such as voice over IP (VoIP), even if there was an HARQ feedback error, having the HARQ receiver send an error report to the HARQ transmitter is unnecessary because the HARQ transmitter does not retransmit the PDU to correct the error.

HARQ feedback error detection may be performed at the RLC/ARQ level. The ARQ transmitter may poll the ARQ receiver for a status report by setting a polling bit in the packet transmitted by the ARQ transmitter. Upon reading the polling bit, the ARQ receiver generates a status report that will provide the acknowledgment status for the last packets received. The ARQ transmitter detects that an error has occurred if it does not receive a status report in response to the poll, or if it receives a status report that indicates that a packet(s) has not been received correctly by the ARQ receiver. The polling method may be useful for isolated packets, since without polling the error can go undetected. However, polling is generally a costly mechanism in terms of overhead, since the ARQ receiver will have to send a status report even when the isolated packet was correctly received. So there is a packet transmission overhead in the form of a status report corresponding to every polled-on packet transmitted in the other direction, which can result in significant overhead.

The ARQ receiver identifies missing packets since RLC segments are numbered. If there is a gap in the SN received at the ARQ receiver, the ARQ receiver autonomously triggers the generation of a status report to inform the ARQ transmitter of the error. This method is useful for the ongoing flow. A timer, (receive error declaration timer), may be used in conjunction with this method in order to allow some time for the missing packet to arrive in case it is simply delayed. This timer can be considered as similar to T1 timer in HSDPA.

The status report may be generated periodically or upon cell change (handover). Since the status report describes the missing packets, it is used to identify errors by the ARQ transmitter. However, this method is slower to report the errors than the above two methods.

In general, ARQ-level error detecting and reporting will make sure that undetected errors by the HARQ-level are caught. However, in some cases it might lead to unnecessary redundancy. For example, if HARQ-level error detection and reporting was done, it is unnecessary to send ARQ-level error detection and reporting messages, (e.g., status PDU).

HARQ-assisted ARQ will have implications on the operation of the ARQ, aside from having to implement the additional local ACK/NACK mechanisms described above. With its local NACK mechanism, ARQ error correction/recovery can be triggered faster without the need for ARQ-level status reports. Since HARQ feedback errors can occur, HARQ-assisted ARQ will also take into account any arriving error reports or status reports that are triggered by detecting HARQ feedback errors at the receiver.

With its local ACK mechanism, window-based flow control can be operated on a timer basis. The RLC transmit window is moved forward based on a timer or counter, because it is assumed that the RLC PDUs can be released from the buffer if there is no HARQ feedback error report or status report requesting a retransmission. However, the RLC buffer controller has to wait for a reasonable period of time (safety timer) to make sure that potential HARQ feedback error or status reports would have arrived before RLC PDUs are released from the buffer, and the transmit window is advanced. This timer will be referred to as transmit window advancing timer.

Hence as opposed to Release 6 where a status report is needed to advance the transmit window, with HARQ-assisted ARQ there is no need to receive the status report to advance the transmit window. The status report only needs to be generated to cover the error cases.

Regarding the ARQ receive window advancing, it has been proposed that ARQ receive window advancing can be based on a timer mechanism in addition to the highest in-sequence SN mechanism that is used in Release 6. A logical channel is configured with maximum allowed delay value, which represents the timer used to advance the ARQ receive window and prevent stalling. This timer is referred to as receive window stall avoidance timer.

The ARQ transmit and receive windows need to be in close synchronization in order to ensure reliable operation. The HARQ-assisted ARQ cannot be fully reliable because in some cases HARQ feedback errors may not be detected in a timely manner, and even if they are detected in a timely manner, it is possible that the HARQ error report or status report can get lost without being detected. Thus, it is possible that the ARQ transmit and receive windows become out of sync.

When the RLC transmit and receive window get out of sync, the ARQ transmitter may transmit packets that are beyond the ARQ receive window's upper edge. The ARQ receiver will reject the packets beyond the upper edge of its receive window, which will result in packet loss. This may happen if the ARQ transmitter generates a local ACK (after waiting for a safety time) thinking that the packet(s) was received correctly by the ARQ receiver, and hence advances its transmit window, while in fact the ARQ receiver did not correctly receive the packet(s) and hence the receive window remains stalled at the lower edge defined by the earliest missing packet. The underlying cause of this window stalling and out-of-sync could be either an undetected HARQ feedback error or an HARQ feedback error that was detected but whose HARQ feedback error report or status report went missing.

The receive window stall avoidance timer may be utilized to alleviate this window stalling problem. However, since there are three timers, transmit window advancing timer, receive window stall avoidance timer and receive error declaration timer that can affect the window-based flow control mechanism, coordination and proper configuration of those timers are important for proper operation.

### SUMMARY

A method and apparatus for controlling ARQ and HARQ transmissions and retransmissions in a wireless communication system is disclosed. A transmitter may send a message to a receiver to instruct to move a receive window if the transmitter is not able to retransmit a packet that is indicated to be retransmitted by at least one of an ARQ status report and an HARQ feedback error report. The receiver may advance the receive window if a currently utilized receive window size exceeds a predetermined percentage of a maximum receive window size, if a highest sequence number (SN) of packets that the receiver has successfully received is within a predetermined percentage of an upper edge of the receive window, if the receiver receives a packet that is beyond an upper edge of the receive window. The receiver may send a message to the transmitter to stop further transmissions if the receiver receives a packet that is beyond an upper edge of the receive window and re-synchronize the transmit window and the receive window. The transmitter may send a message to the receiver to inform a lower edge of the transmit window so that the transmitter and the receiver maintain synchronization of the transmit window and the receive window. The transmitter may determine whether the packet is in an ongoing flow or an isolated packet, and advance the transmit window upon receipt of a local ACK only if the packet is a packet in an ongoing flow and advance the transmit window when the packet is acknowledged by a status report from the receiver only if the packet is an isolated packet.

The transmitter may perform a retransmission in response to at least one of the status report and the HARQ feedback error report based on context in which the retransmission is requested. The transmitter may send an acknowledgement in response to the status report or the HARQ feedback error report to the receiver. The transmitter may send an indication to the receiver whether or not an HARQ feedback error report or a status report is allowed for data contained in the packet and the receiver may send the HARQ feedback error report or the status report only if it is allowed. The receiver may set a prohibit timer when the receiver sends an HARQ feedback error report to the transmitter. The transmission of a consecutive HARQ error report or a status report is then prohibited until the prohibit timer expires. The transmitter may send an indication for a level of robustness and error protection for HARQ feedback and the receiver may adjust the level of robustness and error protection for the HARQ feedback based on the indication.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional RLC C-PDU;

FIG. 2 shows conventional transmit window and receive window; and

FIG. 3 is a block diagram of a system including a transmitter and a receiver in accordance with the present invention.

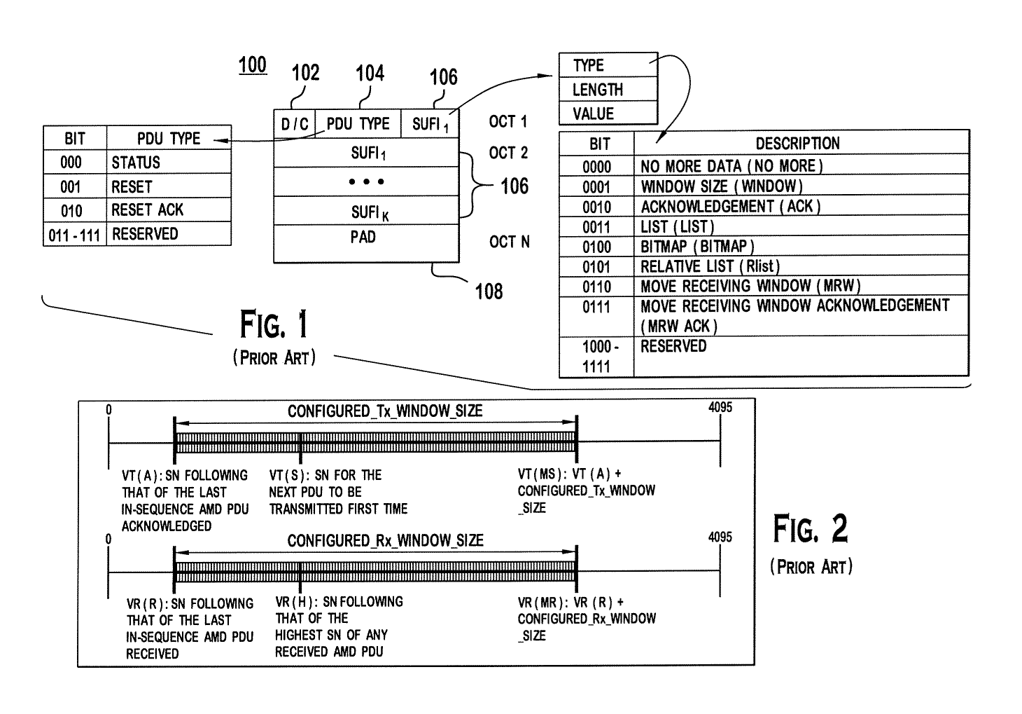

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, a site controller, an access point (AP), or any other type of interfacing device capable of operating in a wireless environment.

The present invention is applicable to any wireless communication systems including, but not limited to, 3GPP LTE and HSPA+. It should be noted that different terminologies and functionalities may be used for different wireless communication systems.

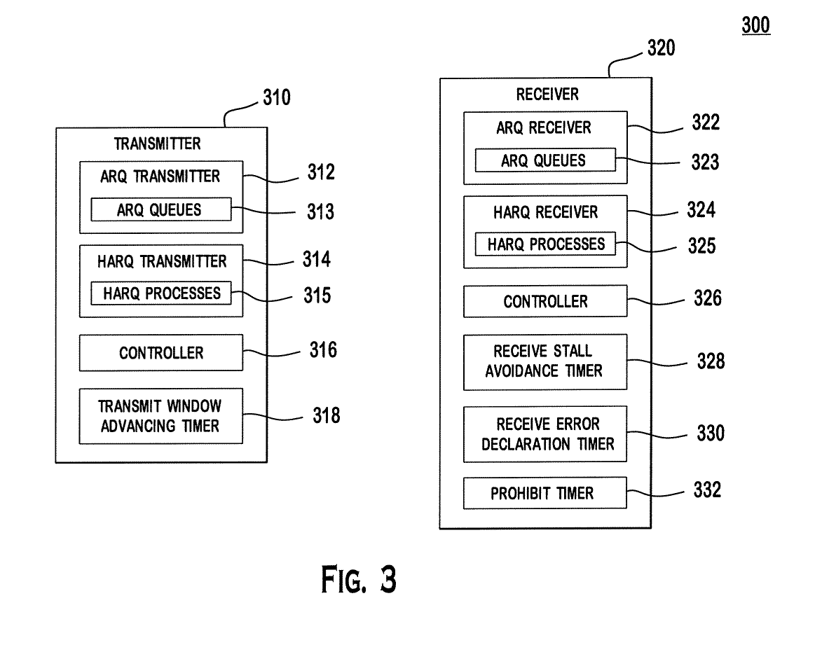

FIG. 3 is a block diagram of a system 300 including a transmitter 310 and a receiver 320 in accordance with the present invention. The transmitter 310 includes an ARQ transmitter 312 including ARQ queues 313, an HARQ transmitter 314 including a plurality of HARQ processes 315, a controller 316, and a transmit window advancing timer 318 (optional). The receiver 320 includes an ARQ receiver 322 including ARQ queues 323, an HARQ receiver 324 including a plurality of HARQ processes 325, a controller 326, a receive window stall avoidance timer 328 (optional), a receive error declaration timer 330 (optional), and a prohibit timer 332 (optional). The transmitter 310 and the receiver 320 implement window-based flow control using a transmit window and a receive window, respectively. The timers 318, 328, 330, and 332 may be a counter, (hereinafter referred to as “timer”).

For proper operation of window-based flow control and error detection and reporting, the configuration of the timers 318, 328, 330, and 332 is coordinated. The coordination may be performed via static or semi-static configuration by the network operator, or via dynamic configuration or negotiation. The transmitter 310 and the receiver 320 exchange signaling messages to communicate the settings of the timers 318, 328, 330, and 332 and any RLC or MAC timers, and to indicate the timers and timer values that they are currently using, and/or the timers and timer values that they recommend or command the other entity to use. Some or all of such signaling messages may be sent by broadcasting, multicasting, or unicasting. Such signaling messages may be performed as a part of a negotiation or setup procedure, (e.g., bearer setup procedures), or may be independent.

For example, it is ensured through the coordination that the transmit window advancing timer value is set larger than the receive error declaration timer value in order to allow the time for detecting and reporting potential errors from the ARQ receiver 322 to the ARQ transmitter 312. One of the transmitter 310 and the receiver 320 may assign values for the transmit window advancing timer 318 and the receive error declaration timer 330 and signals the other of the value it should use for its timer. Alternatively, the transmitter 310 and the receiver 320 may negotiate. The receiver 320 may send the receive error declaration timer value to the transmitter 310, and the transmitter 310 may figure out what the transmitter 310 should use as the transmit window advancing timer value. Alternatively, the transmitter 310 may ask the receiver 320 to use a specific value for the receive error declaration timer 330.

As stated before, the receiver 320 sends a status report and/or an HARQ feedback error report to the transmitter 310. The status report or the HARQ feedback error report may be received by the ARQ transmitter 312 after the ARQ transmitter 312 has freed up a missing packet(s) from the ARQ queues 315 and/or after the ARQ transmitter 312 has advanced its transmit window. This can occur if there is no coordination or consistency between the timers. In such case, the ARQ transmitter 312 will not be able to retransmit the missing packet. In order to avoid stalling at the ARQ receiver 322, if the ARQ transmitter 312 receives an HARQ feedback error report or a status report indicating an error or a NACK concerning the missing packet that the ARQ transmitter 312 has freed up from its buffer, or a packet that lies below the lower edge of its transmit window, the ARQ transmitter 312 sends a signaling message to the ARQ receiver 322 to inform that the ARQ receiver 322 should not wait for the packet but advance its receive window. Such signaling message may be an MRW command.

Methods for avoiding stalling the receive window are explained hereinafter. In accordance with a first embodiment, the ARQ receiver 322 advances its receive window depending on the receive window size that is currently utilized (as measured by the distance between the highest SN of any packet received and accepted by the ARQ receiver 322 and the lower edge of the receive window, or as measured by the number of packets or bytes stored in a memory). For example, if the currently utilized receive window size passes a certain threshold, (e.g., a percentage of the maximum window size), the ARQ receiver 322 advances its receive window.

In accordance with a second embodiment, the ARQ receiver 322 advances its receive window depending on the highest SN of any packet received and accepted by the ARQ receiver 322. For example, if such highest SN lies within a certain threshold from the upper edge of the receive window, the ARQ receiver 322 advances its receive window.

In accordance with a third embodiment, the ARQ receiver 322 advances its receive window by accepting (instead of rejecting) the packets that are beyond the upper-edge of its receive window, and moving its receive window accordingly. For example, if the ARQ receiver 322 receives a packet that has a higher SN than the upper edge of the receive window, the ARQ receiver 322 advances its receive window.

In accordance with a fourth embodiment, upon receiving packets that are beyond the upper-edge of its receive window, the ARQ receiver 322 sends a signaling message to the ARQ transmitter 312 to inform the transmitter 310 of the situation in order to stop further transmissions until the situation is corrected or in order to trigger the necessary procedure to correct the situation.

Such signaling messages may be in the form of a stop/continue procedure, and/or may re-synchronize the two lower edges of the transmit and receive windows, (e.g., via resetting the SN).

In accordance with a fifth embodiment, the ARQ transmitter 312 sends updates that inform the ARQ receiver 322 of the lower edge of the transmit window in order to maintain synchronization and prevent stalling. The updates may be performed periodically, and may be in the form of an MRW command.

The present invention provides a hybrid mode of transmit window advancing method. In accordance with one embodiment, the transmit window is advanced based on the local ACK (preferably after a safety timer) or based on receiving a status report containing an ACK following transmission of the last packet or an isolated packet depending on the context of the packet flow. The transmit window is advanced using a local ACK (with a safety timer) if the flow is an ongoing flow. If the packet is an isolated packet, the transmit window is advanced only if it is acknowledged by the status report which is polled by setting a polling bit.

In Release 6, the transmit and receive windows are defined in terms of the number of RLC PDUs. In LTE, since an RLC PDU may have a variable size, the number of PDUs does not accurately reflect the actual buffer size that will be utilized. The optimum choice for window size definition depends on the receiver buffer implementation choices, (i.e., how the RLC receiver buffer used for re-assembly and reordering is designed and partitioned, and how segmentation and re-segmentation are performed at the transmitter 310). In accordance with the present invention, the window size unit is defined in terms of the number of bytes, the number of slices, the number of PDUs, the number of SDUs, and any combination thereof.

The number of bytes and the number of slices, (where a slice represents N-bytes), provide the finest granularity, but require more processing and calculations at the ARQ transmitter 312, since the ARQ transmitter 312 needs to keep track of the sizes of transmitted PDUs until they are acknowledged. An exemplary window mechanism is explained herein. The transmitter 312 increments the transmit window for a transmitted packet X by the value k. The value k depends on the implementation. For example, the value k may be the number of bytes per transmitted PDU. The value k may be different from one packet to the other. The transmitter 312 then keeps track of the value k for packet X at least until the packet is acknowledged. Upon receiving an acknowledgement, (e.g., via ARQ or HARQ), for the packet, the transmitter 312 updates its transmit window by decrementing the window by k. The transmitter does not transmit packets if the transmit window size equals or exceeds a certain threshold.

The number of PDUs may be used where an RLC PDU size can be changed from one PDU to another. The number of SDUs may be used where an RLC SDU size can be changed from one SDU to another. Using the number of PDUs or SDUs is easier to calculate at the ARQ transmitter 312 since the ARQ transmitter 312 needs to count, (i.e., add or subtract by 1), instead of adding or subtracting by PDU size.

For flexibility and accommodating various receive buffer preferences, the ARQ transmitter 312 and the ARQ receiver 322 exchange information regarding their supported and/or preferred window definitions, (e.g., bytes, slices, PDUs, and SDUs), and perform negotiation to select one or more window definitions. For example, one of the ARQ transmitter 312 and the ARQ receiver 322 may indicate to the other on which basis it can keep track of the window, (e.g., bytes or PDUs), and the other may select a subset of those. Alternatively, the ARQ transmitter 312 and the ARQ receiver 322 are mandated to support all potential window definitions by the standards, and one of the ARQ transmitter 312 and the ARQ receiver 322 may select the window definition to be used. Such negotiations may be combined with other negotiations or setup procedures, such as bearer setup procedures.

In Release 6, some fields, (e.g., SUFI), in the status PDU may be used to communicate the window size. The ARQ receiver 322 is allowed to change the transmission window size of the ARQ transmitter 312 during a connection by utilizing the SUFI in a status PDU. The status PDU may include an additional field to indicate the unit or format of the window size, (e.g., bytes, slices, PDUs, and SDUs), and/or multiple window size fields may be included, each corresponding to different definitions of the window size in order to support more than one window size definition.

The status report notation is changed herein in order to support some of the proposed new segmentation schemes of LTE. For example, in Release 6, the status report identifies the PDU SN for packets that are positively or negatively acknowledged. In LTE, it is proposed that the status report include one or more of 1) the SDU number; 2) the SDU number, segment start offset, (e.g., in bytes), and segment size, (e.g., in bytes); 3) the SDU number, segment start offset, (e.g., in bytes), and segment end offset, (e.g., in bytes); and 4) the SDU number and segment identifier, (e.g., a segment number). In order to increase efficiency and flexibility, context-dependent status report notation is used. Depending on the context in which the status report is generated, the status report utilizes different status report notations. For example, if the ARQ receiver 322 generates a status report in response to a polling trigger, the ARQ receiver 322 may just report the SDU number. If the ARQ receiver 322 generates a status report based on detecting an SN gap, the ARQ receiver 322 may report the SDU number, segment start offset, and segment end offset.

Conventionally, retransmissions can be performed either on RLC PDU (segment level) or RLC SDU (full packet level). In accordance with the present invention, the retransmission is performed based on the context. Under some situations, (e.g., during handover), retransmission needs to be performed for the whole SDU, while under other situation retransmission needs to be performed for the PDU, (i.e., segment). For example, ARQ retransmissions that are triggered by a local NACK, (generated at the transmitter via HARQ-assisted ARQ), is performed on a per-segment basis, (e.g., PDU level), while retransmissions that are triggered by receiving a status report that identifies missing SDUs is performed on a per-SDU basis (full packet). This scheme may be linked to the above context-dependent status report notation.

Multiple status reports that describe the status for different logical channels, (i.e., different ARQ queues), may be aggregated in one aggregated status report in order to increase the efficiency. Such aggregation may be performed by the RLC sub-layer, where the RLC receiver 322 triggers and aggregates the acknowledgement information for more than one logical channel into a single aggregated status report, or may be performed by the MAC sub-layer where the MAC transmitter multiplexes status reports from different logical channels into the same PDU.

As discussed above, status reports may get lost without being detected, causing problems to the operation of window-based flow control. In accordance with the present invention, the ARQ transmitter 312 acknowledges the receipt of the status report, (or C-PDU in general), to the ARQ receiver 322. The ARQ transmitter 312 may use a new PDU type, (such as a status ACK), to acknowledge the status report (status PDU). Alternatively, the ARQ transmitter 312 may use a new SUFI for acknowledging the status PDUs. In order to identify the status PDU (or C-PDU) that is being acknowledged by the acknowledgement packet, sequence numbering for the status PDUs (or for C-PDUs) may be used. Alternatively, the acknowledging packet may repeat some of the fields of the status report (or C-PDU) that is being acknowledged.

Alternatively, the status PDUs (C-PDUs in general) may utilize the RLC ARQ retransmission mechanism for successful delivery. At least one AM ARQ queue is reserved for sending the status PDUs, (C-PDUs in general), for the benefit of ARQ retransmission.

Since acknowledged status reports are needed only in some cases, such as when the ARQ receiver 322 autonomously triggers the generation of the status report, (e.g., based on detecting a missing gap), a status PDU that needs an acknowledgement and a status PDU that does not need an acknowledgement may be distinguished. For example, acknowledgeable status PDUs may have a different type. Alternatively, a status PDU (or C-PDUs in general) may include a field (a bit) to indicate its request for an acknowledgement.

As discussed above, the HARQ feedback error reports may get lost without being detected, causing problems to the operation of window-based flow control. In accordance with the present invention, the HARQ feedback error report that the HARQ receiver 324 sends is acknowledged by the HARQ transmitter 314. A new C-PDU, (e.g., MAC C-PDU), may be used to provide acknowledgements on the HARQ feedback error report.

Alternatively, the HARQ feedback error report that is generated in the HARQ receiver 324 is sent to the ARQ receiver 322 and inserted into an ARQ queue, (e.g., AM queue), for transmission to the ARQ transmitter 312 in order to benefit from AM retransmission functionality and to prevent undetected loss. In general, some or all of the MAC C-PDUs generated in the MAC layer are sent to the RLC/ARQ sub-layer of the receiver 320, and inserted into an ARQ queue, (e.g., AM queue), for transmission to the RLC/ARQ entity in the transmitter 310. Upon reception, the RLC layer of the transmitter 310 forwards the C-PDU down to the MAC layer for processing the control information contained within the packet.

A method for detecting DTX-to-ACK errors is disclosed hereinafter. HARQ PDUs include HARQ-level SNs that are incremented for every new HARQ PDU. An NDI may be viewed as such SN, being a 1-bit indicator that toggles whenever there is a new HARQ PDU. Even though the NDI is mainly designed to flush the receive soft memory when new data is sent, the NDI may be used for detecting the DTX-to-ACK errors. The HARQ receiver 324 examines the HARQ-level SN, (e.g., NDI), in order to detect gaps in the SNs of the received HARQ PDUs, and upon detecting a gap the HARQ receiver 324 declares that the DTX-to-ACK error has occurred. For example, when the HARQ receiver 324 has correctly received and acknowledged an HARQ PDU, if the HARQ receiver 324 receives an HARQ PDU that has the same NDI but that contains a different packet, (as determined by the redundancy version field, by the packet size, or by the packet header information), the HARQ receiver 324 declares that a DTX-to-ACK error might have occurred and hence send an HARQ feedback error report to the HARQ transmitter 314.

As stated above, HARQ feedback error detection and reporting is unnecessary when the HARQ PDU is aborted due to reaching the maximum number of retransmissions at the HARQ transmitter 314, when the HARQ PDU is aborted due to pre-emption by the HARQ transmitter 314 in order to schedule other (higher priority) data, or when the HARQ PDU contains UM or TM traffic instead of AM traffic. In the first and second situation, the cause value method can be used to solve the problem. However, in the third situation, the problem is not solved by using the cause value method, since the cause value field describes the termination cause, (i.e., the cause for ceasing retransmission), of the previous packet, not the content or RLC/ARQ mode of the data itself.

In order to solve the problem in the third situation, a field, (e.g., 1-bit field), is included in the transmitted packet, within the associated HARQ control signaling, or anywhere else, to indicate whether the data contained in the terminated packet, (i.e., the prior HARQ PDU), contains AM data or not, (this field is referred to as AM_or_Not field). When the HARQ receiver 324 sent a NACK and was expecting the HARQ transmitter 314 to retransmit the same HARQ PDU, if the HARQ receiver 324 receives a different HARQ PDU, before declaring that an error has occurred, the HARQ receiver 324 examines the AM_or_Not field of this latter (newly received) HARQ PDU. If the AM_or_Not field indicates that the prior HARQ contained AM data, then the HARQ receiver 324 sends an HARQ feedback error report. Otherwise, the HARQ receiver 324 does not send an HARQ feedback error report.

Alternatively, the HARQ transmitter 314 may include a field, (e.g., 1-bit field), in the transmitted packet, within the associated HARQ control signaling, or anywhere else, to indicate whether an HARQ feedback error report should be sent or not. This field is referred to as either a “Suppress_ER” or “Allow_ER” field. The HARQ transmitter 314 sets the Suppress_ER bit in a subsequent HARQ PDU if the prior terminated HARQ PDU falls in any of the three situations above. Otherwise, the Suppress_ER bit will not be set. For example, if the prior terminated HARQ PDU does not contain AM data, the Suppress_ER field will not be set. If the cause of termination of the prior terminated HARQ PDU was due to pre-emption or due to reaching the maximum number of retransmission attempts, the Suppress_ER field will be set. If the HARQ receiver 324 detects an HARQ feedback error, before declaring that an error has occurred, the HARQ receiver 324 examines the Suppress_ER field of this latter HARQ PDU. If the Suppress_ER field is not set, the HARQ receiver 324 will send an HARQ feedback error report. If the Suppress_ER field is set, the HARQ receiver will not send an HARQ feedback error report.

In yet another alternative, a static, or semi-static, mapping is used between HARQ processes and ARQ queues in a way that AM packets are mapped onto certain HARQ processes while UM or TM packets are mapped onto different HARQ processes. Signaling messages between the transmitter and the receiver are used whereby the transmitter indicates to the receiver whether a certain HARQ process carries AM data or not. If an HARQ feedback error occurs on an HARQ process, the receiver checks if the data on this HARQ process is AM data or not, and if the data is AM data, the receiver generates and sends an HARQ feedback error report. If the data is not AM data, the receiver does not send the HARQ feedback error report.

In general, a configurable parameter for each HARQ process may indicate whether HARQ feedback error reporting is allowed for this HARQ process or not. If an HARQ feedback error occurs on a particular HARQ process, the HARQ receiver checks such parameter to see whether the particular HARQ process is allowed to send HARQ feedback error reports or not, and sends an error report only if it is allowed. The parameters may be configured during a negotiation or setup procedure.

It is unnecessary to send both an HARQ feedback error report and a status report for the same error. In accordance with one embodiment, a prohibit timer 332 may be used to regulate transmission of an HARQ feedback error report at the HARQ-level only. For example, the prohibit timer 332 is used to prohibit sending of consecutive HARQ-level error reports if the time period between two consecutive HARQ error reports is less than a certain threshold. The prohibit timer 332 is used to prohibit generation of a status report after the generation of an HARQ feedback error report for a predetermined time period. For example, HARQ-level error detection and reporting are typically faster than ARQ-level error detection and reporting. When an HARQ feedback error report is sent, the prohibit timer 332 is set and transmission of a status report is prohibited until the prohibit timer 332 expires. The receiver may prohibit status reports on all ARQ queues. Alternatively, HARQ processes and ARQ queues are statically or semi-statically mapped so that the receiver may determine which ARQ queue should have its status reports prohibited once an HARQ feedback error report is sent.

Alternatively, or in conjunction with the above embodiment, an indication may be included in an associated HARQ control channel to indicate the ARQ queue(s), (e.g., logical channel(s) ID), to which the data in this HARQ PDU is destined, or alternatively, to which the data in the prior terminated HARQ PDU was destined. Such information is used to know which ARQ queue(s) should have their status reports prohibited for a certain time-period. This scheme may be used for enhancing RLC/ARQ-level error detection by having status reporting triggered by this event, instead of a missing SN trigger.

In accordance with another embodiment, the Suppress_ER or cause value methods may be used to suppress ARQ-level status reporting. For example, if the receiver decides to suppress sending an HARQ feedback error report based on the Suppress_ER field or the cause value field, the receiver may also suppress the sending of ARQ-level status reports for a certain time period after that, (e.g., the receiver sets a prohibit timer 332 for status reports once the receiver receives a packet whose Suppress_ER or cause value field indicates that it is unnecessary to send an HARQ feedback error report). This scheme is particularly useful if the ARQ transmitter has deliberately stopped retransmitting an HARQ PDU, (e.g., upon reaching a maximum retransmissions), and generated a local ACK, hence it is unnecessary to have the receiver send an HARQ feedback error report or a status report to the transmitter.

In order to improve the robustness of HARQ feedback, the HARQ receiver 324 dynamically adjusts the robustness and/or error protection of HARQ feedback based on an indication or request from the HARQ transmitter 314. The HARQ transmitter 314 dynamically specifies the required level of HARQ feedback robustness and/or error protection based on the particular context or situation and depending on the ability (available mechanisms) to detect potential feedback errors in such contexts or situation. When the HARQ transmitter 314 sends a packet, the HARQ transmitter 314 may specify, (e.g., via 1 bit), in the associated control channel or in-band the level of robustness and/or error protection that the HARQ receiver should apply to the HARQ feedback. In response, the HARQ receiver 324 applies the requested robustness and/or error protection for the HARQ feedback. For example, if the HARQ receiver 324 uses repetition-coding, the HARQ receiver 324 may repeat the HARQ feedback using 10 bits for low robustness and 20 bits for high robustness.

Depending on the context or situation, the HARQ transmitter 314 may dynamically specify the required feedback robustness and/or error protection to the HARQ receiver 324. For example, for the ongoing flow, the HARQ transmitter 314 may request that the HARQ receiver apply lower robustness and/or error protection on the HARQ feedback. For the isolated packet, the HARQ transmitter 314 may request that the HARQ receiver 324 apply higher robustness and/or error protection on the HARQ feedback.

The required level of robustness and/or error protection that the HARQ receiver 324 should apply to the HARQ feedback may be achieved via utilizing a more robust modulation and coding scheme (MCS), via utilizing a more robust channel coding, (e.g., more repetition), via utilizing a more robust diversity mode or multiple-input multiple-output (MIMO) scheme or mode, (e.g., time switched transmit diversity (TSTD) to increase the robustness of HARQ feedback), via utilizing a higher transmit power level, via sending multiple HARQ feedbacks from the HARQ transmitter 314, (i.e., repeating the HARQ feedback messages), and the like.

In addition to signaling the feedback robustness and/or error protection in the transmitted HARQ PDU, in the downlink traffic case, a Node-B may assign resources that a WTRU needs to utilize in order to send the HARQ feedback via L1 control signaling, via a resource assignment message, and the like. In the uplink traffic case, the WTRU signals the feedback robustness and/or error protection request to the Node-B, and the Node-B determines, and signals, the resources for the feedback.

Alternatively, resource assignment may be performed on a static, pre-allocated, or pre-arranged fashion, whereby the receiver knows which resources, (e.g., resource blocks), it should utilize for sending the HARQ feedback if the receiver 300 receives a higher protection request, and which resources it should utilize if the receiver 300 receives a lower protection request. This method is useful for the downlink traffic case. Additionally, the HARQ feedback may be adapted based on channel quality in addition to being adapted based on the feedback robustness request. The level of protection and robustness may be two or more levels.

Although the features and elements are described in the preferred embodiments in particular combinations, each feature or element can be used alone without the other features and elements of the preferred embodiments or in various combinations with or without other features and elements. The methods or flow charts disclosed may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window;
the receiver sending at least one of a status report and a hybrid automatic repeat request (HARQ) feedback error report concerning a missing packet to the transmitter; and
the transmitter sending a message to the receiver to instruct to move the receive window when the missing packet lies below a lower edge of the transmit window.

2. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window; and
the receiver advancing the receive window if a currently utilized receive window size exceeds a predetermined percentage of a maximum receive window size.

3. The method of claim 2 further comprising:
the receiver advancing the receive window if a highest sequence number (SN) of packets that the receiver has successfully received is within a predetermined percentage of an upper edge of the receive window.

4. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window; and
the receiver advancing the receive window if the receiver receives a packet that is beyond an upper edge of the receive window.

5. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window;
the receiver sending a message to the transmitter if the receiver receives a packet that is beyond an upper edge of the receive window; and
the transmitter and the receiver re-synchronizing the transmit window and the receive window.

6. The method of claim 5 further comprising:
the transmitter sending a second message to the receiver to inform a lower edge of the transmit window so that the transmitter and the receiver maintain synchronization of the transmit window and the receive window.

7. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window;
the transmitter determining whether the packet is in an ongoing flow or an isolated packet;
the transmitter advancing the transmit window upon generation of a local acknowledgement (ACK) by a hybrid automatic repeat request (HARQ) entity if the packet is a packet in an ongoing flow; and
the transmitter advancing the transmit window when the packet is acknowledged by a status report from the receiver if the packet is an isolated packet.

8. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window;
the transmitter advancing the transmit window using a status report received from the receiver if the packet has been polled for acknowledgement; and
the transmitter advancing the transmit window upon generation of a local acknowledgement (ACK) by a hybrid automatic repeat request (HARQ) entity if the packet has not been polled for acknowledgement.

9. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window; and
the transmitter and the receiver performing a negotiation to select definition of at least one of the transmit window and the receive window to be used for transmission and reception of the packet between the transmitter and the receiver.

10. The method of claim 9 wherein the size of the transmit window and the receive window is defined in terms of at least one of the number of bytes, the number of slices, the number of protocol data units (PDUs), and the number of service data units (SDUs).

11. The method of claim 9 wherein a status PDU from the receiver includes a field indicating window size definition.

12. The method of claim 11 wherein the status PDU includes multiple window size fields, each window size field corresponding to different definitions of the window size.

13. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window; and
the receiver sending a status report regarding successful or unsuccessful receipt of the packet, wherein the receiver generates a status report utilizing a different status report notation depending on context in which the status report is generated.

14. The method of claim 13 wherein if the receiver generates the status report in response to a polling trigger from the transmitter, the receiver includes only a service data unit (SDU) number in the status report.

15. The method of claim 13 wherein if the receiver generates the status report based on detecting a sequence number (SN) gap, the receiver includes a service data unit (SDU) number, a segment start offset, and a segment size.

16. The method of claim 13 wherein if the receiver generates the status report based on detecting a sequence number (SN) gap, the receiver includes a service data unit (SDU) number, a segment start offset, and a segment end offset.

17. The method of claim 13 wherein if the receiver generates the status report based on detecting a sequence number (SN) gap, the receiver includes a service data unit (SDU) number and a segment identifier.

18. In a wireless communication system including a transmitter and a receiver, a method for controlling transmission and retransmission of a packet, the method comprising:
the transmitter sending a packet to the receiver using a transmit window;
the receiver receiving the packet from the transmitter using a receive window;
the receiver sending at least one of a status report regarding successful or unsuccessful receipt of the packet and a hybrid automatic repeat request (HARQ) feedback to the transmitter; and
the transmitter performing a retransmission in response to at least one of the status report and the HARQ feedback, wherein the retransmission is performed on a per-segment basis when the retransmission is triggered by a local negative acknowledgement (NACK) by a HARQ entity of the transmitter.

19. The method of claim 18 wherein the retransmission is performed on a per-service data unit (SDU) basis when the retransmission is triggered by receiving a status report that identifies a missing SDU.

20. In a wireless communication system including a transmitter and a receiver, the transmitter including an automatic repeat request (ARQ) transmitter and a hybrid ARQ (HARQ) transmitter and the receiver including an ARQ receiver and an HARQ receiver, a method for controlling transmission and retransmission of a packet, the method comprising:
the ARQ transmitter sending a packet to the ARQ receiver using a transmit window;
the ARQ receiver receiving the packet from the ARQ transmitter using a receive window;
the ARQ receiver sending a status report to the ARQ transmitter; and
the ARQ transmitter sending an acknowledgement in response to the status report to the ARQ receiver.

21. The method of claim 20 wherein the ARQ transmitter uses a protocol data unit (PDU) to acknowledge the status report.

22. The method of claim 20 wherein the ARQ transmitter uses a super field (SUFI) in a control protocol data unit (PDU) for acknowledging the status report.

23. The method of claim 20 wherein a sequence number is used for the status report so that the status report is acknowledged using the sequence number.

24. The method of claim 20 wherein the ARQ transmitter includes at least a portion of the status report in a packet for acknowledgment.

25. The method of claim 20 wherein at least one acknowledged mode (AM) ARQ queue is reserved for sending the status report, so that the status report is transmitted utilizing an ARQ retransmission mechanism for successful delivery.

26. The method of claim 20 wherein a status report that needs an acknowledgement and a status report that does not need an acknowledgement are distinguished.

27. The method of claim 26 wherein the status report that needs an acknowledgement and a status report that does not need acknowledgement have a different protocol data unit (PDU) type.

28. The method of claim 26 wherein the status report includes a field to indicate whether an acknowledgement is requested or not.

29. The method of claim 20 further comprising:
the HARQ receiver sending an HARQ feedback error report to the HARQ transmitter; and
the HARQ transmitter sending an acknowledgement to the HARQ receiver in response to the HARQ feedback error report.

30. The method of claim 29 further comprising:
the HARQ receiver sending the HARQ feedback error report to the ARQ receiver;
the ARQ receiver sending the HARQ feedback error report to the ARQ transmitter using an ARQ retransmission mechanism;
the ARQ transmitter receiving the HARQ feedback error report; and
the ARQ transmitter sending the HARQ feedback error report to the HARQ transmitter.

31. In a wireless communication system including a transmitter and a receiver, a method for controlling transmission and retransmission of a packet, the method comprising:
the transmitter sending a packet to the receiver;
the transmitter sending an indication to the receiver to indicate whether or not at least one of a hybrid automatic repeat request (HARQ) feedback error report and a status report is allowed for data contained in the packet;
the receiver receiving the packet and the indication; and
the receiver sending at least one of the HARQ feedback error report and the status report for the received packet only if transmission of the HARQ feedback error report or the status report is indicated to be allowed.

32. The method of claim 31 wherein the transmitter includes the indication in the transmitted packet.

33. In a wireless communication system including a transmitter and a receiver, a method for controlling transmission and retransmission of a packet, the method comprising:
the transmitter sending a packet to the receiver using one of a plurality of automatic repeat request (ARQ) queues and one of a plurality of hybrid automatic repeat request (HARQ) processes, the ARQ queues and the HARQ processes being mapped in a way that acknowledged mode (AM) packets are mapped onto certain HARQ processes while unacknowledged mode (UM) and transparent mode (TM) packets are mapped onto other ARQ processes;
the receiver receiving the packet from the transmitter; and
the receiver sending feedback to the received packet only if it is determined to be an AM packet.

34. In a wireless communication system including a transmitter and a receiver, a method for controlling transmission and retransmission of a packet, the method comprising:
the transmitter sending a packet to the receiver;
the receiver receiving the packet from the transmitter; and
the receiver setting a prohibit timer when the receiver sends a hybrid automatic repeat request (HARQ) feedback error report to the transmitter, wherein a transmission of at least one of a consecutive HARQ error report and a status report is prohibited until the prohibit timer expires.

35. The method of claim 34 wherein HARQ processes and automatic repeat request (ARQ) queues are mapped in a predetermined way and the prohibit timer is applied to a particular HARQ process.

36. In a wireless communication system including a transmitter and a receiver, a method for controlling transmission and retransmission of a packet, the method comprising:
the transmitter sending a packet to the receiver;
the transmitter sending an indication for a level of robustness and error protection for hybrid automatic repeat request (HARQ) feedback;
the receiver receiving the packet and the indication; and
the receiver adjusting the level of robustness and error protection for the HARQ feedback to be sent in response to the received packet based on the indication.

37. The method of claim 36 wherein the HARQ transmitter applies a lower level of robustness and error protection for an ongoing flow and applies a higher level of robustness and error protection for an isolated packet.

38. The method of claim 36 wherein the transmitter assigns resources to the receiver for the HARQ feedback.

39. The method of claim 38 wherein the transmitter assigns the resources in response to a request from the receiver.

40. The method of claim 36 wherein resource assignment is pre-arranged so that the receiver applies specific resources for sending the HARQ feedback depending on the indicated level of robustness and error protection.

41. In a wireless communication system including a transmitter and a receiver, the transmitter and the receiver using at least one timer for controlling a window-based flow control, a method for controlling transmission and retransmission of a packet, the method comprising:
the transmitter sending a packet to the receiver using a transmit window;
the receiver receiving the packet from the transmitter using a receive window; and
the transmitter and the receiver exchanging a signaling message to coordinate configuration of the timer.

42. The method of claim 41 wherein the transmitter uses a transmit window advancing timer for advancing the transmit window.

43. The method of claim 42 wherein the receiver uses at least one of a receive window stall avoidance timer, a receive error declaration timer, and a prohibit timer.

44. The method of claim 43 wherein the transmit window advancing timer is set longer than the receive error declaration timer.

45. The method of claim 41 wherein the signaling message is exchanged during a setup procedure.

46. A transmitter for controlling transmission and retransmission of a packet in a wireless communication system, the transmitter comprising:
a hybrid automatic repeat request (HARQ) transmitter for sending a packet to a receiver using an HARQ mechanism; and
an automatic repeat request (ARQ) transmitter for sending a packet to the receiver using an ARQ mechanism, the ARQ transmitter sending the packet using a transmit window and the receiver receiving the packet using a receive window, the ARQ transmitter being configured to send a message to the receiver to instruct to move the receive window when a missing packet identified by one of a status report and an HARQ feedback error report lies below a lower edge of the transmit window.

47. A transmitter for controlling transmission and retransmission of a packet in a wireless communication system, the transmitter comprising:
a hybrid automatic repeat request (HARQ) entity for sending a packet using an HARQ mechanism; and
an automatic repeat request (ARQ) transmitter for sending a packet using a transmit window, the ARQ transmitter being configured to determine whether the packet is a packet in an ongoing flow or an isolated packet, advance the transmit window upon generation of a local acknowledgement (ACK) by the HARQ entity only if the packet is a packet in an ongoing flow, and advance the transmit window when the packet is acknowledged by a received status report only if the packet is an isolated packet.

48. A transmitter for controlling transmission and retransmission of a packet in a wireless communication system, the transmitter comprising:
a hybrid automatic repeat request (HARQ) entity for sending and receiving a packet to and from a receiver using an HARQ mechanism; and
an automatic repeat request (ARQ) transmitter for sending a packet to the receiver using a transmit window, the ARQ transmitter being configured to advance the transmit window using a status report received from the receiver if the packet has been polled for acknowledgement and advance the transmit window upon generation of a local acknowledgement (ACK) by the HARQ entity if the packet has not been polled for acknowledgement,

49. A transmitter for controlling transmission and retransmission of a packet in a wireless communication system, the transmitter comprising:
an automatic repeat request (ARQ) transmitter for sending a packet to a receiver using a transmit window, the receiver using a receive window for receiving the packet; and
a controller configured to perform a negotiation to select definition of at least one of the transmit window and the receive window to be used for transmission and reception of the packet between the transmitter and the receiver.

50. The transmitter of claim 49 wherein the size of the transmit window and the receive window is defined in terms of at least one of the number of bytes, the number of slices, the number of protocol data units (PDUs), and the number of service data units (SDUs).

51. The transmitter of claim 49 wherein a status PDU from the receiver includes a field indicating window size definition.

52. The transmitter of claim 51 wherein the status PDU includes multiple window size fields, each window size field corresponding to different definitions of the window size.

53. A transmitter for controlling transmission and retransmission of a packet in a wireless communication system, the transmitter comprising:
a hybrid automatic repeat request (HARQ) transmitter for sending a packet to a receiver using an HARQ mechanism; and
an automatic repeat request (ARQ) transmitter for sending a packet to the receiver using an ARQ mechanism,
wherein the ARQ transmitter is configured to perform a retransmission in response to at least one of a status report and an HARQ feedback from the receiver on a per-segment basis when the retransmission is triggered by a local negative acknowledgement (NACK) by the HARQ transmitter.

54. The transmitter of claim 53 wherein the ARQ transmitter performs the retransmission on a per-service data unit (SDU) basis when the retransmission is triggered by receiving a status report that identifies a missing SDU.

55. A transmitter for controlling transmission and retransmission of a packet in a wireless communication system, the transmitter comprising:
a hybrid automatic repeat request (HARQ) transmitter for sending a packet using an HARQ mechanism; and
an automatic repeat request (ARQ) transmitter for sending a packet using an ARQ mechanism, the ARQ transmitter being configured to send an acknowledgement in response to a received status report.

56. The transmitter of claim 55 wherein the ARQ transmitter uses a protocol data unit (PDU) to acknowledge the status report.

57. The transmitter of claim 55 wherein the ARQ transmitter uses a super field (SUFI) in a control protocol data unit (PDU) for acknowledging the status report.

58. The transmitter of claim 55 wherein a sequence number is used for the status report so that the status report is acknowledged using the sequence number.

59. The transmitter of claim 55 wherein the ARQ transmitter includes at least a portion of the status report in a packet for acknowledgment.

60. The transmitter of claim 55 wherein the HARQ transmitter is configured to send an acknowledgement to the receiver in response to an HARQ feedback error report.

61. A transmitter for controlling transmission and retransmission of a packet in a wireless communication system, the transmitter comprising:
a hybrid automatic repeat request (HARQ) transmitter for transmitting a packet using an HARQ mechanism; and
an automatic repeat request (ARQ) transmitter for transmitting a packet using an ARQ mechanism, the ARQ transmitter being configured to send an indication whether or not at least one of an HARQ feedback error report and a status report is allowed for data contained in the packet, whereby the transmitter receives at least one of the HARQ feedback error report and the status report only if it is allowed.

62. The transmitter of claim 61 wherein the ARQ transmitter includes the indication in the transmitted packet.

63. A transmitter for controlling transmission and retransmission of a packet in a wireless communication system, the transmitter comprising:
a plurality of hybrid automatic repeat request (HARQ) processes for sending a packet to a receiver using an HARQ mechanism; and
an automatic repeat request (ARQ) transmitter including a plurality of ARQ queues for sending a packet to the receiver using an ARQ mechanism, the ARQ transmitter being configured to map HARQ processes and ARQ queues in a way that acknowledged mode (AM) packets are mapped onto certain HARQ processes while unacknowledged mode (UM) and transparent mode (TM) packets are mapped onto other HARQ processes, wherein the receiver sends feedback to a received packet only if it is determined to be an AM packet.

64. A transmitter for controlling transmission and retransmission of a packet in a wireless communication system, the transmitter comprising:
a hybrid automatic repeat request (HARQ) transmitter for sending a packet to a receiver using an HARQ mechanism; and
an automatic repeat request (ARQ) transmitter for sending a packet to the receiver using an ARQ mechanism, the ARQ transmitter being configured to send an indication for a level of robustness and error protection for HARQ feedback, whereby the receiver adjusts the level of robustness and error protection for the HARQ feedback based on the indication.

65. The transmitter of claim 64 wherein the ARQ transmitter configures a lower level of robustness and error protection for an ongoing flow and a higher level of robustness and error protection for an isolated packet.

66. The transmitter of claim 64 further comprising:
a scheduler configured to assign resources to the receiver for the HARQ feedback.

67. The transmitter of claim 66 wherein the scheduler assigns the resources in response to a request from the receiver.

68. A transmitter for controlling transmission and retransmission of a packet in a wireless communication system, the transmitter comprising:
an automatic repeat request (ARQ) transmitter for sending a packet to a receiver using an ARQ mechanism, the ARQ transmitter sending the packet using a transmit window and the receiver receiving the packet using a receive window;
a hybrid automatic repeat request (HARQ) transmitter for sending the packet using an HARQ mechanism;
a timer for implementing a window-based flow control; and
a controller configured to exchange a signaling message to coordinate configuration of the timer with the receiver.

69. The transmitter of claim 68 wherein the timer is a transmit window advancing timer for advancing the transmit window.

70. A receiver for controlling transmission and retransmission of a packet in a wireless communication system, the receiver comprising:
a hybrid automatic repeat request (HARQ) receiver for receiving a packet using an HARQ mechanism; and
an automatic repeat request (ARQ) receiver for receiving a packet using an ARQ mechanism, the packet having been transmitted in a transmit window and the ARQ receiver receiving the packet using a receive window, the ARQ receiver being configured to advance the receive window if a currently utilized receive window size exceeds a predetermined percentage of a maximum receive window size.

71. The receiver of claim 70 wherein the ARQ receiver is configured to advance the receive window if a highest sequence number (SN) of packets that the receiver has successfully received is within a predetermined percentage of an upper edge of the receive window.

72. A receiver for controlling transmission and retransmission of a packet in a wireless communication system, the receiver comprising:
a hybrid automatic repeat request (HARQ) receiver for receiving a packet from a transmitter using an HARQ mechanism; and
an automatic repeat request (ARQ) receiver for receiving a packet from the transmitter using an ARQ mechanism, the transmitter sending the packet using a transmit window and the ARQ receiver receiving the packet using a receive window, the ARQ receiver being configured to advance the receive window if the receiver receives a packet that is beyond an upper edge of the receive window.

73. A receiver for controlling transmission and retransmission of a packet in a wireless communication system, the receiver comprising:
a hybrid automatic repeat request (HARQ) receiver for receiving a packet using an HARQ mechanism; and
an automatic repeat request (ARQ) receiver for receiving a packet using an ARQ mechanism, the packet having been transmitted in a transmit window and the ARQ receiver receiving the packet using a receive window, the ARQ receiver being configured to send a message to the transmitter if the ARQ receiver receives a packet that is beyond an upper edge of the receive window so that the transmitter and the ARQ receiver re-synchronize the transmit window and the receive window.

74. A receiver for controlling transmission and retransmission of a packet in a wireless communication system, the receiver comprising:
a hybrid automatic repeat request (HARQ) receiver for receiving a packet using an HARQ mechanism; and
an automatic repeat request (ARQ) receiver for receiving a packet using an ARQ mechanism, the packet having been transmitted in a transmit window and the ARQ receiver receiving the packet using a receive window, the ARQ receiver being configured to perform a negotiation to select definition of at least one of the transmit window and the receive window.

75. The receiver of claim 74 wherein the size of the transmit window and the receive window is defined in terms of at least one of the number of bytes, the number of slices, the number of protocol data units (PDUs), and the number of service data units (SDUs).

76. A receiver for controlling transmission and retransmission of a packet in a wireless communication system, the receiver comprising:
a hybrid automatic repeat request (HARQ) receiver for receiving a packet from a transmitter using an HARQ mechanism; and
an automatic repeat request (ARQ) receiver for receiving a packet from the transmitter using an ARQ mechanism, the ARQ receiver being configured to generate a status report utilizing a different status report notation depending on context in which the status report is generated.

77. The receiver of claim 76 wherein if the ARQ receiver generates the status report in response to a polling trigger from the transmitter, the ARQ receiver includes only a service data unit (SDU) number in the status report.

78. The receiver of claim 76 wherein if the ARQ receiver generates the status report based on detecting a sequence number (SN) gap, the ARQ receiver includes a service data unit (SDU) number, a segment start offset, and a segment size.

79. The receiver of claim 76 wherein if the ARQ receiver generates the status report based on detecting a sequence number (SN) gap, the ARQ receiver includes a service data unit (SDU) number, a segment start offset, and a segment end offset.

80. The receiver of claim 76 wherein if the ARQ receiver generates the status report based on detecting a sequence number (SN) gap, the ARQ receiver includes a service data unit (SDU) number and a segment identifier.

81. A receiver for controlling transmission and retransmission of a packet in a wireless communication system, the receiver comprising:
a hybrid automatic repeat request (HARQ) receiver for receiving a packet from a transmitter using an HARQ mechanism; and
an automatic repeat request (ARQ) receiver for receiving a packet from the transmitter using an ARQ mechanism,
wherein the ARQ receiver and the HARQ receiver are configured to generate and send at least one of an HARQ feedback error report and a status report only if it is indicated as allowed.

82. The receiver of claim 81 wherein the indication is provided by the transmitter in the transmitted packet.

83. A receiver for controlling transmission and retransmission of a packet in a wireless communication system, the receiver comprising:
a hybrid automatic repeat request (HARQ) receiver for receiving a packet using an HARQ mechanism; and
an automatic repeat request (ARQ) receiver for receiving a packet using an ARQ mechanism,
wherein HARQ processes and ARQ queues are mapped in a way that acknowledged mode (AM) packets are mapped onto certain HARQ processes while unacknowledged mode (UM) and transparent mode (TM) packets are mapped onto other HARQ processes, and the ARQ receiver and the HARQ receiver are configured to generate and send at least one of an HARQ feedback error report and a status report only for the AM packets.

84. A receiver for controlling transmission and retransmission of a packet in a wireless communication system, the receiver comprising:
a hybrid automatic repeat request (HARQ) receiver including a plurality of HARQ processes for receiving a packet using an HARQ mechanism;
an automatic repeat request (ARQ) receiver including ARQ queues for receiving a packet using an ARQ mechanism; and
a prohibit timer for controlling transmission of an HARQ feedback error report and a status report, the prohibit timer being set when the HARQ receiver transmits an HARQ feedback error report,
wherein a transmission of at least one of a consecutive HARQ error report and a status report is prohibited until the prohibit timer expires.

85. The receiver of claim 84 wherein the HARQ processes and the ARQ queues are mapped in a predetermined way and the prohibit timer is applied to a particular HARQ process.

86. A receiver for controlling transmission and retransmission of a packet in a wireless communication system, the receiver comprising:
a hybrid automatic repeat request (HARQ) receiver for receiving a packet from a transmitter using an HARQ mechanism, the HARQ receiver sending HARQ feedback to the transmitter; and
an automatic repeat request (ARQ) receiver for receiving a packet from the transmitter using an ARQ mechanism,
wherein the HARQ receiver adjusts a level of robustness and error protection for the HARQ feedback based on an indication indicated by the transmitter.

87. A receiver for controlling transmission and retransmission of a packet in a wireless communication system, the receiver comprising:
a hybrid automatic repeat request (HARQ) receiver for receiving a packet from a transmitter using an HARQ mechanism;
an automatic repeat request (ARQ) receiver for receiving a packet from the transmitter using an ARQ mechanism, the transmitter sending the packet using a transmit window and the ARQ receiver receiving the packet using a receive window;
a timer for implementing a window-based flow control; and
a controller configured to exchange a signaling message to coordinate configuration of the timer with the transmitter.

88. The receiver of claim 87 wherein the timer includes at least one of a receive window stall avoidance timer, a receive error declaration timer, and a prohibit timer.
